(19) United States
(12) Patent Application Publication
(10) Pub. No.: US 2004/0122149 A1
(43) Pub. Date: Jun. 24, 2004

(54) Flame-retardant polyvinyl chloride compositions

(76) Inventors: Vishal S. Kadakia, Marlboro, MA (US); Robert S. Brookman, Providence, RI (US); Raman Patel, Cumberland, RI (US); John C. Andries, East Greenwich, RI (US); Maryellen Cox, Warwick, RI (US)

Correspondence Address: ROBERT C. NABINGER, Fish & Richardson P.C., 225 Franklin Street, Boston, MA, 02110-2804, US

(21) Appl. No.: 10/326,021

(22) Filed: Dec. 19, 2002

(51) Int. Cl. C08K 3/10

(52) U.S. Cl. 524/406; 524/436

(57) ABSTRACT

Flame-retardant compositions of a polyvinyl chloride resin, a polyolefin, and a flame retardant are disclosed. The compositions are essentially free of plasticizers from the group consisting of: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof. The compositions possess good flame retardancy, as well as good mechanical properties and good low temperature flexibility.

### BACKGROUND

This invention relates to flame-retardant compositions of polyvinyl chloride (PVC) resins and polyolefins. A variety of flame-retardant compositions for cable jacketing and wire insulation based upon PVC are known. These compositions typically contain, in addition to PVC, one or more flame retardants, plasticizers, lubricants, and/or fillers. It is desirable for these compositions to exhibit low smoke generation and low flame travel.

### SUMMARY

In general, the invention relates to flame-retardant compositions of polyvinyl chloride (PVC) resins and polyolefins. The compositions preferably are essentially free of non-flame-retardant plasticizers. In other words, the compositions are essentially free of: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof. Non-flame-retardant plasticizers are listed in the Encyclopedia of PVC: Compound Design and Additives (Leonard I. Nass & Charles A. Heiberger, eds., 2nd ed. 1987), which is hereby incorporated by reference in its entirety. The Handbook of PVC Formulating (Edward J. Wickson, ed., John Wiley & Sons ©1993) describes flame-retardant plasticizers, and is hereby incorporated by reference in its entirety.

In one aspect, the invention features a composition containing a PVC resin, a polyolefin, and a flame retardant in the amount of at least about 50 parts per 100 parts (by weight) PVC resin. The composition is essentially free of the following plasticizers: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof.

In another aspect, the invention features a composition containing a PVC resin, a polyolefin, and a flame retardant in the amount of at least about 50 parts per 100 parts PVC resin. The composition also contains less than about 30 parts of the following plasticizers per 100 parts PVC resin: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof.

In another aspect, the invention features a composition containing a PVC resin, a polyolefin, a flame retardant in the amount of at least about 50 parts per 100 parts PVC resin, and a phosphate ester plasticizer. The composition is essentially free of the following plasticizers: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof.

In another aspect, the invention features a composition containing a PVC resin, a polyolefin, a flame retardant in the amount of at least about 50 parts per 100 parts PVC resin, and a phosphate ester plasticizer. The composition contains less than about 30 parts of the following plasticizers per 100 parts PVC resin: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof.

In another aspect, the invention features a composition containing a PVC resin, a polyolefin, and a flame-retardant plasticizer in the amount of at least about 50 parts per 100 parts PVC resin. The composition is essentially free of the following plasticizers: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof.

In another aspect, the invention features a composition containing a PVC resin, a polyolefin, and a flame-retardant plasticizer in the amount of at least about 50 parts per 100 parts PVC resin. The compositions contain less than about 30 parts of the following non-flame-retardant plasticizers per 100 parts PVC resin: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof.

In another aspect, the invention features a composition containing a PVC resin, a polyolefin, and a flame retardant. The composition also contains polycaprolactone, chlorinated polyethylene, or a combination of polycaprolactone and chlorinated polyethylene. The composition is essentially free of the following plasticizers: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof.

In another aspect, the invention features a composition containing a PVC resin, a polyolefin, and a flame retardant. The composition also contains polycaprolactone, chlorinated polyethylene, or a combination of polycaprolactone and chlorinated polyethylene. The composition contains less than about 30 parts of the following plasticizers per 100 parts PVC resin: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof.

Embodiments may include one or more of the following features. The composition may include at least about 30, 50, 70, 90, 110, 130, or 150 parts of polyolefin per 100 parts PVC resin. The composition may include an inorganic flame retardant, and the inorganic flame retardant may be magnesium hydroxide or ammonium octamolybdate. The composition may contain an organic flame retardant, and the organic flame retardant may be a phosphate ester plasticizer. The composition may include at least about 70, 90, 110, 130, or 150 parts flame retardant per 100 parts PVC resin.

In some embodiments, the composition may contain less than about 20, 10, 5, or 1 parts of the following plasticizers per 100 parts PVC resin: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof.

The compositions may contain polycaprolactone and/or chlorinated polyethylene.

Other features and advantages of the invention will be apparent from the following description of the preferred embodiments thereof, and from the claims.

### DETAILED DESCRIPTION

A flame-retardant composition is provided that contains a PVC resin, a polyolefin, and a flame retardant. The composition is essentially free of plasticizers from the group consisting of: citrates; non-halogenated phthalates (e.g., di-2-ethyl-hexyl, di-n-octyl, dioctyl, diisooctyl, diisodecyl, dibutyl, dihexyl, or diheptylnonyl); bisphthalates; benzoates; trimellitates; pyromellitates; azelates; polymeric plasticizers based on adipic, azelaic, or sebacic acids and glycols such as ethylene, propylene, and butylene, with either alcohol or monobasic acid termination (e.g., benzoate diester of 2,2,4-trimethyl pentanediol or triethylene glycol di-2-ethylhexanoate); epoxies; esters of dibasic acids (e.g., aliphatic ester adipates such as dioctyl adipate, aliphatic ester sebacates such as dioctyl sebacate); alkyl sulfonate esters; aliphatic hydrocarbons; aromatic hydrocarbons; alkylated aromatic hydrocarbons; butyl phthalyl butyl glycollate; isobutyrate; dipentaerythritol esters; and combinations thereof. The composition optionally contains additives such as lubricants, stabilizers, antioxidants, processing aids, and fillers.

“Polyvinyl chloride” or “PVC,” as used herein, includes homopolymers of vinyl chloride, as well as polymerization products of vinyl chloride and one or more co-monomers. For example, the PVC resin can be a copolymer of vinyl chloride and ethylene, or a copolymer of vinyl chloride and propylene. The PVC resin can also be the polymerization product of vinyl chloride and an ester monomer having the formula H₂C═C(R¹)C(═O)OR², where R¹ and R² are, independently, C₁₋₁₂ alkyl. An example of such a resin is a copolymer of a vinyl chloride monomer and a methyl methacrylate monomer. Another example of such a resin is a copolymer of a vinyl chloride monomer and a vinyl acetate monomer. Combinations of these PVC resins may also be used.

The compositions contain a polyolefin. Preferred polyolefins include a copolymer of ethylene and 1-octene that is a metallocene-catalyzed reaction product of these two monomers, available from DuPont-Dow Elastomers under the trade name ENGAGE (e.g., ENGAGE 8150, ENGAGE 8440, and ENGAGE 8452). Another example of a polyolefin is a copolymer of ethylene and 1-butene, available from Exxon Chemicals under the trade name EXACT (e.g., EXACT 3035). Other examples of polyolefins include homopolymers (e.g., polyethylene or polypropylene) and copolymers (e.g., a copolymer of ethylene and propylene (EP rubber), a copolymer of ethylene, propylene, and a non-conjugated diene monomer (EPDM), a copolymer of ethylene and an alpha-olefin having at least four carbons, ethylene-propylene rubber (EPR), and butyl rubber (i.e., polyisobutene copolymer)). The above-mentioned may be used alone or in combination. Preferably, the compositions contain at least about 30 parts, and more preferably from about 30 parts to about 150 parts, of the polyolefin per 100 parts of the PVC resin.

The compositions contain a flame retardant or a combination of flame retardants. The flame retardants can be liquid or solid. Preferred flame retardants include aluminum trihydroxide, available from various suppliers, including Alcoa, under the product name Hydrated Aluminas; magnesium hydroxide, available from various suppliers, including Albermarle, under the trade name MAGNIFIN (e.g., Magnifin H-10 or Magnifin H-5); flame-retardant phosphate ester plasticizers, available from various suppliers, including Ferro, under the trade name SANTICIZER (e.g., Santicizer 2148); and ammonium octamolybdate, available from various suppliers, including Polymer Additives Group, under the trade name Climax AOM. Additional flame retardants are described in Linsky et al., U.S. Pat. No. 5,886,072, which is hereby incorporated by reference in its entirety. The compositions preferably include at least about 50 parts total flame retardant per 100 parts polyvinyl chloride resin, and more preferably from about 50 parts to about 200 parts total flame retardant per 100 parts polyvinyl chloride resin.

The compositions can also contain a compatibilizer, e.g., chlorinated polyethylene (CPE) or polycaprolactone, or combinations thereof. Another example of a compatibilizer is TU-polymer, commercially available from Kuraray. TU-polymer is a SEPTON™ and polyurethane block copolymer. Another example of a compatibilizer is styrene acrylonitrile grafted polybutadiene. Generally, the compatibilizer can have one portion that is miscible with the PVC and a second portion that is miscible with the polyolefin. For example, the compatibilizer can be a diblock copolymer. Alternatively, the compatibilizer can be a graft copolymer. The compatibilizer improves the compatibility of the PVC resin and the polyolefin, thereby imparting desired mechanical properties to the resulting compositions. Preferably, the compositions contain at least about 10 parts, and more preferably from about 20 parts to about 120 parts total compatibilizer (based on 100 parts by weight of the PVC resin). Suitable compatibilizers are further described in Polymeric Compatibilizers —Uses and Benefits in Polymer Blends (Sudhin Datta & David J. Lohse, 1996), which is hereby incorporated by reference in its entirety.

When CPE is present in the compositions, it is preferred that the compositions contain at least 10 parts, more preferably from about 20 parts to about 60 parts, of CPE (based on 100 parts by weight of the PVC resin), and that the CPE has a chlorine content of about 5% to about 50% by weight. It is also preferred that the CPE is the chlorinated product of a slurry process. The chlorination process generally decreases the crystallinity of the material; it is preferred that the CPE has a residual polyethylene crystallinity of at least about 0.5% (measured by differential scanning calorimetry). Preferred CPE's are commercially available, for example, from Dow Chemical under the trade name TYRIN (e.g., Tyrin 3623A).

When polycaprolactone is present in the compositions, it is preferred that the compositions contain at least 10 parts, more preferably from about 20 parts to about 60 parts, of polycaprolactone (based on 100 parts by weight of the PVC resin). Preferably, polycaprolactone present in the compositions has a molecular weight ranging from about 10,000 to about 60,000. A preferred polycaprolactone is commercially available from Solvay under the trade name CAPA (e.g., CAPA 640). The PVC compositions may also contain ingredients such as lubricants, stabilizers, antioxidants, processing aids and fillers. Examples of suitable lubricants include stearic acid, metal salts of stearic acid, wax, and polyethylene glycols. The lubricants may be used alone or in combination. Preferred lubricants include stearic acid, available from various suppliers, including Henkel Corporation, as Stearic Acid GP Grade.

Examples of suitable stabilizers include barium/zinc heat stabilizers, calcium/zinc heat stabilizers, lead stabilizers, other mixed metal complex heat stabilizers, and organic heat stabilizers. The stabilizers may be used alone or in combination. Preferred stabilizers include a tin stabilizer, available from various suppliers, including Crompton Corporation under the trade name MARK 1900, and perchlorate stabilizer, available from Crompton Corporation, under the trade name Mark TS-607.

Examples of suitable antioxidants include phenolic and thioester antioxidants. The antioxidants may be used alone or in combination. A preferred antioxidant is tetrakis[methylene (3,5-di-t-butyl-4-hydroxylhydrocinnamate)]methane, available from various suppliers, including Ciba Geigy, under the trade name IRGANOX (e.g., Irganox 1010).

Examples of suitable processing aids include acrylic-based processing aids. The processing aids may be used alone or in combination. A preferred processing aid is available from various suppliers, including Rohm and Haas, under the trade name PARALOID (e.g., Paraloid K-125).

Examples of suitable fillers include Kaolin clay, calcium carbonate, and other fillers commonly used in PVC compositions. The fillers may be used alone or in combination. The compositions preferably exhibit a peak heat release rate of less than about 600 kW/m², and more preferably less than about 300 kW/m². Moreover, the compositions preferably have an average heat release rate of less than about 250 kW/m², and more preferably less than about 200 kW/m².

Additionally, the compositions preferably exhibit an average heat of combustion of less than about 30 MJ/kg, and more preferably less than about 25 MJ/kg.

The compositions preferably have a peak smoke of less than about 7 m^{-l}, and more preferably less than about 5 m⁻¹.

The preferred compositions exhibit a brittle point of no greater than about −25° C., preferably, about −25° C. to about −50° C.; and an elongation at break of at least about 100%, preferably, about 100% to about 500%.

The compositions are generally prepared according to conventional dry blend techniques or other methods known to those skilled in the art of PVC compounding. These methods are further described in U.S. Ser. No. 09/566,835, filed May 8, 2000, which is hereby incorporated by reference in its entirety.

The mixtures obtained from the blending process are then melt mixed in a mixer such as a BANBURY batch mixer, a Farrel Continuous Mixer, or a single or twin screw extruder.

The compositions are useful in a variety of applications. For example, these compositions are useful in applications in which it is desirable for compositions to maintain good flame retardancy and/or good mechanical properties and a low brittle point. Such applications include wire and cable insulation and jacketing.

In the following examples, the contents and properties of a number of preferred compositions are described. These compositions were prepared as follows. The ingredients were mixed in a #3 BANBURY internal mixer at 60 psi steam pressure, speed 5, for approximately 5 minutes, or until the temperature reached 330-360° F. The resultant mix was milled in a heated two-roll mill, then cooled to room temperature (25° C.). Test specimens were prepared according to ASTM protocols as follows. The cooled milled sheets were used for compression molding. Test plaques were compression molded into 1/16″-⅛″ plaques at temperatures of 160-190° C. ASTM test pieces were then die cut from the compression molded plaques. All tests were carried out according to the appropriate ASTM protocols.

### EXAMPLES

Five compositions were prepared containing the following ingredients (based on 100 parts of polyvinyl chloride resin):

| | Compo- | Compo- | Compo- | Compo- | Compo- |
|---|---|---|---|---|---|
| | sition | sition | sition | sition | sition |
| INGREDIENT | 1 | 2 | 3 | 4 | 5 |
| Polyvinyl Chloride | 100 | 100 | 100 | 100 | 100 |
| Resin | | | | | |
| Heat Stabilizer (1)² | 3 | 3 | 3 | 3 | 3 |
| Heat Stabilizer (2)³ | 4 | 4 | 4 | 4 | 4 |
| Lubricant (1)⁴ | 1 | 1 | 1 | 1 | 1 |
| Antioxidant⁵ | 1 | 1 | 1 | 1 | 1 |
| Flame Retardant (1)⁶ | 100 | 0 | 150 | 0 | 75 |
| Flame Retardant (2)⁷ | 0 | 0 | 0 | 150 | 75 |
| Flame Retardant (3)⁸ | 0 | 0 | 15 | 15 | 15 |
| Flame Retardant (4)⁹ | 0 | 0 | 15 | 15 | 15 |
| Chlorinated | 40 | 40 | 40 | 40 | 40 |
| Polyethylene¹⁰ | | | | | |
| Polyolefin¹¹ | 70 | 70 | 70 | 70 | 70 |
| Polycaprolactone¹² | 30 | 30 | 15 | 0 | 0 |
| Processing Aid¹³ | 2 | 2 | 2 | 2 | 2 |

¹OXY 200, commercially available from Oxy Vinyl.
²Mark TS-607, commercially available from Crompton Corporation.
³MARK 1900, commercially available from Crompton Corporation.
⁴Stearic Acid, commercially available from Cognis Corporation.
⁵IRGANOX 1010, commercially available from Ciba Geigy.
⁶Magnifin H-10, commercially available from Albermarle.
⁷Magnifin H-5, commercially available from Albermarle.
⁸Santicizer 2148, commercially available from Ferro.
⁹Climax AOM, commercially available from Polymer Additives Group.
¹⁰TYRIN 3623A (36% chlorine content), commercially available from Dow Chemical Company.
¹¹ENGAGE EG-8150, a metallocene-catalyzed polymerization product of ethylene and 1-octene (with melt flow index (dg/min) = 0.5), commercially available from DuPont-Dow Elastomers.
¹²CAPA 640 (Tₘ = 60° C.; m.w. = 37,000), commercially available from Solvay.
¹³Paraloid K-125, commercially available from Rohm and Haas Company.

The compositions exhibit the following physical properties (as tested according to the designated ASTM procedure):

| | ASTM | | | | | |
|---|---|---|---|---|---|---|
| Test Description | Procedure | Comp. 1 | Comp. 2 | Comp. 3 | Comp. 4 | Comp. 5 |
| Hardness (inst/15 | D-2240 | C84/76 | C80/73 | C83/78 | C91/86 | C90/85 |
| sec) | | | | | | |
| Specific Gravity | D-297 | 1.33 | 1.14 | 1.45 | 1.47 | 1.46 |
| Oxygen Index (%) | D-2863 | 27 | 23 | 32 | 34.5 | 34 |
| Ultimate | D-412 | 328 | 325 | 178 | 153 | 159 |
| Elongation (%) | | | | | | |
| Tensile at Break | D-412 | 2347 | 2404 | 2051 | 1925 | 2121 |
| (psi) | | | | | | |
| Dielectric | D-150 | 3.128 | 2.799 | 3.34 | 3.34 | 3.33 |
| Constant (1 MHz) | | | | | | |
| Dissipation Factor | D-150 | 0.0061 | 0.0061 | 0.0242 | 0.0319 | 0.0309 |
| (1 MHz) | | | | | | |
| Viscosity (188° C., | D-3835 | 2409 | 1730 | 2673 | 3723 | 3736 |
| 20/1 die ratio, 100 | | | | | | |
| sec⁻¹) | | | | | | |
| Viscosity (188° C., | D-3835 | 472 | 364 | 520 | 574 | 580 |
| 20/1 die ratio, | | | | | | |
| 1000 sec⁻¹) | | | | | | |
| Brittle Point | D-746 | <−60 | <−60 | −35 | −40 | −36 |
| (Original) (° C.) | | | | | | |
| Peak Heat Release | E-1354 | 137 | 714 | 105 | 85 | 73 |
| Rate (kW/m²) | | | | | | |
| Average Heat | E-1354 | 84 | 353 | 61 | 52 | 46 |
| Release Rate | | | | | | |
| (kW/m²) | | | | | | |
| Total Heat | E-1354 | 122 | 158 | 104 | 82 | 80 |
| Release Rate | | | | | | |
| (MJ/m²) | | | | | | |
| Average Heat of | E-1354 | 20 | 22 | 20 | 16 | 15 |
| Combustion | | | | | | |
| (MJ/kg) | | | | | | |
| Specific | E-1354 | 731 | 1212 | 352 | 318 | 241 |
| Extinction Area | | | | | | |
| (m²/kg) | | | | | | |
| Peak Smoke (m⁻¹) | E-1354 | 3.5 | 10.5 | 2.2 | 2.5 | 1.7 |

The brittle point is the temperature below which a composition becomes brittle, rather than ductile and flexible.

As the above table illustrates, composition 2 has no flame retardant additives. The preferred compositions (i.e., 1, 3, 4, and 5) include flame retardants. The preferred compositions have good flame retardancy. Additionally, the preferred compositions have good mechanical properties such as tensile strength and elongation, and also a low brittle point.

All publications, patents, and patent applications mentioned in this application are herein incorporated by reference to the same extent as if each individual publication, patent, or patent application were specifically and individually indicated to be incorporated by reference.

Other embodiments are within the following claims.

What is claimed is:

1. A composition comprising:
(a) a polyvinyl chloride resin;
(b) a polyolefin; and
(c) a flame retardant in the amount of at least about 50 parts per 100 parts polyvinyl chloride resin,
wherein the composition is essentially free of plasticizers selected from the group consisting of citrates, non-halogenated phthalates, bisphthalates, benzoates, trimellitates, pyromellitates, azelates, adipic acid polymers, azelaic acid polymers, sebacic acid polymers, ethylene glycol polymers, propylene glycol polymers, butylene glycol polymers, pentylene glycol polymers, epoxies, dibasic acid esters, alkyl sulfonate esters, aliphatic hydrocarbons, aromatic hydrocarbons, alkylated aromatic hydrocarbons, butyl phthalyl butyl glycollate, isobutyrate, and dipentaerythritol esters, and combinations thereof.

2. The composition of claim 1, wherein the composition includes at least about 30 parts of polyolefin per 100 parts polyvinyl chloride resin.

3. The composition of claim 1, wherein the composition includes at least about 50 parts of polyolefin per 100 parts polyvinyl chloride resin.

4. The composition of claim 1, wherein the composition includes at least about 70 parts of polyolefin per 100 parts polyvinyl chloride resin.

5. The composition of claim 1, wherein the composition includes at least about 90 parts of polyolefin per 100 parts polyvinyl chloride resin.

6. The composition of claim 1, wherein the composition includes at least about 110 parts of polyolefin per 100 parts polyvinyl chloride resin.

7. The composition of claim 1, wherein the composition includes at least about 130 parts of polyolefin per 100 parts polyvinyl chloride resin.

8. The composition of claim 1, wherein the composition includes at least about 150 parts of polyolefin per 100 parts polyvinyl chloride resin.

9. The composition of claim 1, wherein the flame retardant comprises an inorganic flame retardant.

10. The composition of claim 9, wherein the flame retardant is selected from the group consisting of magnesium hydroxide and ammonium octamolybdate.

11. The composition of claim 10, wherein the flame retardant comprises magnesium hydroxide.

12. The composition of claim 10, wherein the flame retardant comprises ammonium octamolybdate.

13. The composition of claim 1, wherein the flame retardant comprises an organic flame retardant.

14. The composition of claim 13, wherein the flame retardant comprises a phosphate ester plasticizer.

15. The composition of claim 1, wherein the composition contains at least about 70 parts flame retardant per 100 parts polyvinyl chloride resin.

16. The composition of claim 1, wherein the composition contains at least about 90 parts flame retardant per 100 parts polyvinyl chloride resin.

17. The composition of claim 1, wherein the composition contains at least about 110 parts flame retardant per 100 parts polyvinyl chloride resin.

18. The composition of claim 1, wherein the composition contains at least about 130 parts flame retardant per 100 parts polyvinyl chloride resin.

19. The composition of claim 1, wherein the composition contains at least about 150 parts flame retardant per 100 parts polyvinyl chloride resin.

20. A composition comprising:
(a) a polyvinyl chloride resin;
(b) a polyolefin;
(c) a flame retardant in the amount of at least about 50 parts per 100 parts polyvinyl chloride resin; and
(d) less than about 30 parts plasticizer per 100 parts of polyvinyl chloride resin, wherein the plasticizer is selected from the group consisting of citrates, non-halogenated phthalates, bisphthalates, benzoates, trimellitates, pyromellitates, azelates, adipic acid polymers, azelaic acid polymers, sebacic acid polymers, ethylene glycol polymers, propylene glycol polymers, butylene glycol polymers, pentylene glycol polymers, epoxies, dibasic acid esters, alkyl sulfonate esters, aliphatic hydrocarbons, aromatic hydrocarbons, alkylated aromatic hydrocarbons, butyl phthalyl butyl glycollate, isobutyrate, and dipentaerythritol esters, and combinations thereof.

21. The composition of claim 20, wherein the composition contains less than about 20 parts plasticizer per 100 parts of polyvinyl chloride resin.

22. The composition of claim 21, wherein the composition contains less than about 10 parts plasticizer per 100 parts of polyvinyl chloride resin.

23. The composition of claim 22, wherein the composition contains less than about 5 parts plasticizer per 100 parts of polyvinyl chloride resin.

24. The composition of claim 23, wherein the composition contains less than about 1 part plasticizer per 100 parts of polyvinyl chloride resin.

25. A composition comprising:
(a) a polyvinyl chloride resin;
(b) a polyolefin;
(c) a flame retardant in the amount of at least about. 50 parts per 100 parts polyvinyl chloride resin; and
(d) a phosphate ester plasticizer,
wherein the composition is essentially free of plasticizers selected from the group consisting of citrates, non-halogenated phthalates, bisphthalates, benzoates, trimellitates, pyromellitates, azelates, adipic acid polymers, azelaic acid polymers, sebacic acid polymers, ethylene glycol polymers, propylene glycol polymers, butylene glycol polymers, pentylene glycol polymers, epoxies, dibasic acid esters, alkyl sulfonate esters, aliphatic hydrocarbons, aromatic hydrocarbons, alkylated aromatic hydrocarbons, butyl phthalyl butyl glycollate, isobutyrate, and dipentaerythritol esters, and combinations thereof.

26. A composition comprising:
(a) a polyvinyl chloride resin;
(b) a polyolefin;
(c) a flame retardant in the amount of at least about 50 parts per 100 parts polyvinyl chloride resin;
(d) a phosphate ester plasticizer; and
(e) less than about 30 parts plasticizer per 100 parts of polyvinyl chloride resin, wherein the plasticizer is selected from the group consisting of citrates, non-halogenated phthalates, bisphthalates, benzoates, trimellitates, pyromellitates, azelates, adipic acid polymers, azelaic acid polymers, sebacic acid polymers, ethylene glycol polymers, propylene glycol polymers, butylene glycol polymers, pentylene glycol polymers, epoxies, dibasic acid esters, alkyl sulfonate esters, aliphatic hydrocarbons, aromatic hydrocarbons, alkylated aromatic hydrocarbons, butyl phthalyl butyl glycollate, isobutyrate, and dipentaerythritol esters, and combinations thereof.

27. The composition of claim 26, wherein the composition contains less than about 20 parts plasticizer per 100 parts of polyvinyl chloride resin.

28. The composition of claim 27, wherein the composition contains less than about 10 parts plasticizer per 100 parts of polyvinyl chloride resin.

29. The composition of claim 28, wherein the composition contains less than about 5 parts plasticizer per 100 parts of polyvinyl chloride resin.

30. The composition of claim 29, wherein the composition contains less than about 1 part plasticizer per 100 parts of polyvinyl chloride resin.

31. A composition comprising:
(a) a polyvinyl chloride resin;
(b) a polyolefin; and
(c) a flame-retardant plasticizer, in the amount of at least about 50 parts per 100 parts polyvinyl chloride resin,
wherein the composition is essentially free of plasticizers selected from the group consisting of citrates, non-halogenated phthalates, bisphthalates, benzoates, trimellitates, pyromellitates, azelates, adipic acid polymers, azelaic acid polymers, sebacic acid polymers, ethylene glycol polymers, propylene glycol polymers, butylene glycol polymers, pentylene glycol polymers, epoxies, dibasic acid esters, alkyl sulfonate esters, aliphatic hydrocarbons, aromatic hydrocarbons, alkylated aromatic hydrocarbons, butyl phthalyl butyl glycollate, isobutyrate, and dipentaerythritol esters, and combinations thereof.

32. A composition comprising:
(a) a polyvinyl chloride resin;
(b) a polyolefin;
(c) a flame-retardant plasticizer, in the amount of at least about 50 parts per 100 parts polyvinyl chloride resin; and
(d) less than about 30 parts non-flame-retardant plasticizer per 100 parts of polyvinyl chloride resin, wherein the non-flame-retardant plasticizer is selected from the group consisting of citrates, non-halogenated phthalates, bisphthalates, benzoates, trimellitates, pyromellitates, azelates, adipic acid polymers, azelaic acid polymers, sebacic acid polymers, ethylene glycol polymers, propylene glycol polymers, butylene glycol polymers, pentylene glycol polymers, epoxies, dibasic acid esters, alkyl sulfonate esters, aliphatic hydrocarbons, aromatic hydrocarbons, alkylated aromatic hydrocarbons, butyl phthalyl butyl glycollate, isobutyrate, and dipentaerythritol esters, and combinations thereof.

33. The composition of claim 32, wherein the composition contains less than about 20 parts non-flame-retardant plasticizer per 100 parts of polyvinyl chloride resin.

34. The composition of claim 33, wherein the composition contains less than about 10 parts non-flame-retardant plasticizer per 100 parts of polyvinyl chloride resin.

35. The composition of claim 34, wherein the composition contains less than about 5 parts non-flame-retardant plasticizer per 100 parts of polyvinyl chloride resin.

36. The composition of claim 35, wherein the composition contains less than about 1 part non-flame-retardant plasticizer per 100 parts of polyvinyl chloride resin.

37. A composition comprising:
(a) a polyvinyl chloride resin;
(b) a polyolefin;
(c) a flame retardant; and
(d) a component selected from the group consisting of polycaprolactone and chlorinated polyethylene, and combinations thereof,
wherein the composition is essentially free of plasticizers selected from the group consisting of citrates, non-halogenated phthalates, bisphthalates, benzoates, trimellitates, pyromellitates, azelates, adipic acid polymers, azelaic acid polymers, sebacic acid polymers, ethylene glycol polymers, propylene glycol polymers, butylene glycol polymers, pentylene glycol polymers, epoxies, dibasic acid esters, alkyl sulfonate esters, aliphatic hydrocarbons, aromatic hydrocarbons, alkylated aromatic hydrocarbons, butyl phthalyl butyl glycollate, isobutyrate, and dipentaerythritol esters, and combinations thereof.

38. The composition of claim 37, wherein the component comprises polycaprolactone.

39. The composition of claim 37, wherein the component comprises chlorinated polyethylene.

40. The composition of claim 37, wherein the composition further comprises a flame-retardant plasticizer.

41. The composition of claim 37, wherein the composition further comprises a phosphate ester plasticizer.

42. A composition comprising:
(a) a polyvinyl chloride resin;
(b) a polyolefin;
(c) a flame retardant;
(d) a component selected from the group consisting of polycaprolactone and chlorinated polyethylene, and combinations thereof; and
(e) less than about 30 parts plasticizer per 100 parts of polyvinyl chloride resin, wherein the plasticizer is selected from the group consisting of citrates, non-halogenated phthalates, bisphthalates, benzoates, trimellitates, pyromellitates, azelates, adipic acid polymers, azelaic acid polymers, sebacic acid polymers, ethylene glycol polymers, propylene glycol polymers, butylene glycol polymers, pentylene glycol polymers, epoxies, dibasic acid esters, alkyl sulfonate esters, aliphatic hydrocarbons, aromatic hydrocarbons, alkylated aromatic hydrocarbons, butyl phthalyl butyl glycollate, isobutyrate, and dipentaerythritol esters, and combinations thereof.

43. The composition of claim 42, wherein the composition contains less than about 20 parts plasticizer per 100 parts of polyvinyl chloride resin.

44. The composition of claim 43, wherein the composition contains less than about 10 parts plasticizer per 100 parts of polyvinyl chloride resin.

45. The composition of claim 44, wherein the composition contains less than about 5 parts plasticizer per 100 parts of polyvinyl chloride resin.

46. The composition of claim 45, wherein the composition contains less than about 1 part plasticizer per 100 parts of polyvinyl chloride resin.

47. The composition of claim 42, wherein the component comprises polycaprolactone.

48. The composition of claim 42, wherein the component comprises chlorinated polyethylene.

49. The composition of claim 42, wherein the composition further comprises a flame-retardant plasticizer.

50. The composition of claim 42, wherein the composition further comprises a phosphate ester plasticizer.
